(19) United States
(12) Patent Application Publication
(10) Pub. No.: US 2005/0238573 A1
(43) Pub. Date: Oct. 27, 2005

(54) Systems and methods for hydrogen generation from solid hydrides

(76) Inventors: Qinglin Zhang, Manalpan, NJ (US); Richard M. Mohring, East Brunswick, NJ (US); Ying Wu, Red Bank, NJ (US)

Correspondence Address: DICKSTEIN SHAPIRO MORIN & OSHINSKY LLP, 2101 L Street, NW, Washington, DC, 20037, US

(21) Appl. No.: 11/105,549

(22) Filed: Apr. 14, 2005

Related U.S. Application Data
(60) Provisional application No. 60/647,394, filed on Jan. 28, 2005.
(60) Provisional application No. 60/562,132, filed on Apr. 14, 2004.

(51) Int. Cl. C01B 3/02

(52) U.S. Cl. 423/648.1

(57) ABSTRACT

A system is disclosed for hydrogen generation based on hydrolysis of solid chemical hydrides with the capability of controlled startup and stop characteristics wherein regulation of acid concentration, acid feed rate, or a combination of both control the rate of hydrogen generation. The system comprises a first chamber for storing a solid chemical hydride and a second chamber for storing an acidic reagent. The solid chemical hydride is a solid metal borohydride having the general formula MBH₄, where M is selected from the group consisting of alkali metal cations, alkaline earth metal cations, aluminum cation, zinc cation, and ammonium cation. The acidic reagent may comprise inorganic acids such as the mineral acids hydrochloric acid, sulfuric acid, and phosphoric acid, and organic acids such as acetic acid, formic acid, maleic acid, citric acid, and tartaric acid, or mixtures thereof.

This application claims the benefit of U.S. Provisional Application Ser. No. 60/647,394, filed Jan. 28, 2005, and of U.S. Provisional Application Ser. No. 60/562,132, filed Apr. 14, 2004, the entire disclosures of both of which are incorporated herein by reference.

### FIELD OF THE INVENTION

The present invention relates to the generation of hydrogen from a fuel that is stored in solid form and from which hydrogen is generated using an acidic reagent.

### BACKGROUND OF THE INVENTION

Hydrogen is the fuel of choice for fuel cells. However, its widespread use is complicated by the difficulties in storing the gas. Many hydrogen carriers, including hydrocarbons, metal hydrides, and chemical hydrides are being considered as hydrogen storage and supply systems. In each case, specific systems need to be developed in order to release the hydrogen from its carrier, either by reformation as in the case of hydrocarbons, desorption from metal hydrides, or catalyzed hydrolysis from chemical hydrides and water.

Complex chemical hydrides, such as sodium borohydride and lithium borohydride, have been investigated as hydrogen storage media as the gravimetric hydrogen storage density of sodium borohydride is 10.8% and lithium borohydride is 18%. Sodium borohydride has garnered particular interest, because it can be dissolved in alkaline water solutions with virtually no reaction; hydrogen is not generated until the solution contacts a catalyst to promote hydrolysis. In a typical heterogeneous catalyzed system, the stoichiometric reaction of borohydrides with water to produce hydrogen gas and a borate is illustrated by the following chemical reaction:
NaBH₄+2H₂O→NaBO₂+4H₂+300kJ (1)

Generators that utilize a sodium borohydride fuel solution and a heterogeneous catalyst system typically require at least three chambers, one each to store fuel and borate product, and a third chamber containing the catalyst. Hydrogen generation systems can also incorporate additional balance of plant components such as hydrogen ballast tanks, heat exchangers, condensers, gas-liquid separators, filters, and pumps. Such system designs may be accommodated in portable and stationary systems; however, the associated balance of plant is not suitable for micro fuel cell applications where volume is at a premium, as in consumer electronics.

A further limitation in the use of aqueous fuel solutions is related to the shelf life of the liquid fuel. The liquid fuel is stable at temperatures below 40° C., which is sufficient for those applications which consume fuel in an ongoing manner. However, hydrogen can evolve as the temperature increases. Excessive hydrogen accumulation in the fuel cartridge is undesirable in applications such as consumer electronics.

Further, to maintain the borohydride and borate solids in solution, an amount of water beyond that needed for the stoichiometric reaction is required. Water is thus removed from the system by the formation of hydrated borate compounds as depicted by equation (2) below:
MBH₄+4H₂O→MBO₂.2H₂O+4H₂+heat (2)

In addition, liquid water is lost during the reaction to vaporization. Excess water must be added to compensate for this loss. All of these factors contribute to water/borohydride ratios significantly greater than 4:1 for practical hydrogen generation systems based on the heterogeneous catalysis of borohydride fuel solutions. This excess water limits the effective hydrogen storage density.

Systems for hydrogen generation based on solid chemical hydrides typically involve introducing water to a bed of a reactive hydride for hydrolysis. Such uncatalyzed systems are limited to the more reactive chemical hydrides such as sodium hydride, lithium hydride, and calcium hydride. For borohydride compounds, the simple reaction with water is slow and either a heterogeneous catalyst is incorporated into the mixture, or the solid is simply used for storage and is converted into a liquid fuel for hydrogen generation.

### BRIEF SUMMARY OF THE INVENTION

The present invention provides hydrogen generation methods and systems that produce hydrogen by the reaction of a solid chemical hydride with a reagent system in the presence of water.

One embodiment of the present invention provides a hydrogen generation system that comprises a first chamber for storing a solid chemical hydride and a second chamber for storing an acidic reagent solution in the vicinity of the first chamber. The solid chemical hydride is a solid metal borohydride having the general formula MBH₄, where M is selected from the group consisting of alkali metal cations, alkaline earth metal cations, aluminum cation, zinc cation, and ammonium cation, and is preferably sodium, potassium, lithium, or calcium. The chemical hydride may be provided in the form of powder, granules, or pellets, for example. The acidic solution may comprise any suitable acid, including for example, inorganic acids such as the mineral acids hydrochloric acid (HCl), sulfuric acid (H₂SO₄), and phosphoric acid (H₃PO₄), and organic acids such as acetic acid (CH₃COOH), formic acid (HCOOH), maleic acid, citric acid, and tartaric acid.

Another embodiment of the present invention provides a method of generating hydrogen by reacting a solid chemical hydride with an acidic reagent in the presence of water. The method comprises (i) providing a solid borohydride of formula M(BH₄)ₙ, wherein M is selected from the group consisting of alkali metal cations, alkaline earth metal cations, aluminum cation, zinc cation, and ammonium cation, and n corresponds to the charge of the selected M cation; and (ii) contacting an acidic reagent solution having a pH lower than about 7 with the solid borohydride in the presence of water to generate hydrogen.

The invention also provides systems for controlling hydrogen gas generation. In one embodiment, such system comprises a first region for containing a solid borohydride; a second region for containing a reagent solution having a pH of less than about 7; and at least one gas permeable membrane in contact with the first region. The membrane is capable of allowing hydrogen to pass through the membrane while preventing solid and liquid materials from passing through the membrane. The system further includes a conduit for conveying the reagent solution from the second region to the first region, a hydrogen gas outlet in communication with the first region, and a control mechanism for regulating the flow of reagent solution or concentration from the second region to the first region. We have found that fast start and stop dynamics to provide on/off control and to regulate the rate of hydrogen production can be achieved in systems and methods according to the invention by regulating the rate of reagent solution addition to the solid borohydride, the concentration of the acid, or both.

The accompanying drawings together with the detailed description herein illustrate these and other embodiments and serve to explain the principles of the invention. Other features and advantages of the present invention will also become apparent from the following description of the invention which refers to the accompanying drawings.

### BRIEF DESCRIPTION OF THE DRAWINGS

FIG. 1 is a schematic illustration of a hydrogen generator system in accordance with the present invention with water, solid fuel, and liquid reagent storage areas;

FIG. 2 is a schematic illustration of a hydrogen generator system in accordance with the present invention with solid fuel, and liquid reagent storage areas;

FIGS. 3A, 3B, and 3C are graphs illustrating the rate of hydrogen generation and temperature as a function of time for the reaction of sodium borohydride with 3% HCl solutions;

FIG. 4 is a graph illustrating the rate of hydrogen generation and temperature as a function of time for the reaction of sodium borohydride with 10% HCl solution;

FIG. 5 is a graph illustrating the rate of hydrogen generation and temperature as a function of time for the reaction of sodium borohydride with 12% HCl solution;

FIG. 6 is a graph illustrating the rate of hydrogen generation and temperature as a function of time for the reaction of sodium borohydride with 10% HCl solution with multiple start/stop cycles for acid feed; and

FIG. 7 is a graph illustrating the rate of hydrogen flow as a function of time according to one embodiment of the systems and methods of the present invention.

### DETAILED DESCRIPTION OF THE INVENTION

The present invention provides an acid catalyzed hydrolysis system which converts a solid chemical hydride fuel to hydrogen. Multiphase reactions in which an aqueous acid solution directly contacts a solid chemical hydride to produce a solid or slurry product provide advantages over conventional heterogeneous reaction involving an aqueous chemical hydride solution and solid catalysts. For instance, the effective energy density is increased by eliminating the concentration limit inherent in liquid fuel based systems, and system complexity and balance of plant (BOP) can both be reduced since a discrete catalyst bed is not necessary.

To maximize the storage density, it is highly desirable to reach a H₂OOto BH₄— molar ratio approaching the room-temperature stoichiometric limit. When an acid solution is used in place of a solid heterogeneous catalyst system, the reaction stoichiometry is affected and the conjugate base of the acid is incorporated into the borate byproduct, which typically results in less hydrated borate salts, thus sequestering less water. Additionally, when both the borohydride and the borate salts are in the solid state, the limitation imposed by solubility is removed.

The chemical hydride fuel component useful in an exemplary hydrogen generation system based on acid catalyzed hydrolysis according to the present invention is a solid metal borohydride having the general formula MBH₄, where M is selected from the group consisting of alkali metal cations, alkaline earth metal cations, aluminum cation, zinc cation, and ammonium cation, and is preferably sodium, potassium, lithium, or calcium. Examples of such compounds include without intended limitation NaBH₄, KBH₄, LiBH₄, and Ca(BH₄)₂. These chemical hydrides may be utilized in mixtures or individually. Preferred for such systems in accordance with the present invention is NaBH₄.

Hydrogen generation systems according to the present invention generate hydrogen by contacting a fuel with an acidic reagent. The fuel may be a complex metal hydride, e.g., sodium borohydride (NaBH₄), which is stored in solid form. Mixtures of complex metal hydrides can be used to maximize solubility of the borate product. For example, mixtures of KBH₄ and NaBH₄ form eutectic-like phases and may be employed to result in soluble borate salts. The acidic reagent, i.e., a reagent having a pH less than about 7, may be in an aqueous solution or may be in solid form, the latter requiring the presence of water to transform the solid complex metal hydride fuel into hydrogen and a metal metaborate (“discharged fuel”). The term “solid form” encompasses any substantially dry form, including powder, granules or pellets. Suitable acidic reagents include, but are not limited to, both inorganic acids such as the mineral acids hydrochloric acid (HCl), sulfuric acid (H₂SO₄), and phosphoric acid (H₃PO₄), and organic acids such as acetic acid (CH₃COOH), formic acid (HCOOH), maleic acid, citric acid, and tartaric acid, among others. The acidic reagents may also comprise a combination of organic and/or inorganic acids. Preferably, the acidic reagent is an acidic solution containing predominantly the acidic reagent.

A secondary water soluble co-catalyst such as a transition metal catalyst, for example, the chloride salts of cobalt (COCl₂), nickel (NiCl₂), or copper (CuCl₂), may be optionally added to the acid solution to further catalyze the reaction. In such case, as the reagent solution contacts the borohydride, the metal ion will be reduced by the borohydride and will deposit as metal particles or metal boride compounds in the fuel compartment. These materials will accumulate in the fuel compartment as the borohydride is consumed. Since these materials can also catalyze hydrolysis of borohydride, the increased concentration of metal catalyst with increased time of operation will ensure that the borohydride fuel is completely converted to hydrogen.

The solid hydride may be anhydrous or hydrated and preferably contains less than about 50 wt-% water. The hydrated forms of certain borohydride salts, notably sodium borohydride, exist at low to moderate temperatures. For example, sodium borohydride dihydrate (NaBH₄.2H₂O, 51.2 wt-% NaBH₄ and 48.8 wt-% water) is formed at temperatures below 36.4° C., potassium borohydride trihydrate exists at temperatures below 7.5° C., and potassium borohydride monohydrate exists at temperatures below 37.5° C.

The solid metal borohydride fuel component may be combined with a solid stabilizer agent selected from the group consisting of metal hydroxides, anhydrous metal metaborates, and hydrated metal metaborates, and mixtures thereof. Stabilized fuel compositions comprising borohydride and hydroxide salts are disclosed in co-pending U.S. patent application Ser. No. 11/068,838 entitled “Borohydride Fuel Composition and Methods,” filed on Mar. 2, 2005, the disclosure of which is incorporated by reference herein in its entirety.

In one embodiment of the present invention, an acid catalyzed hydrolysis system is provided in which sodium borohydride in solid form is stored in the vicinity of an aqueous solution of the acidic reagent. In this embodiment, generation of hydrogen starts by bringing the stored components into contact with one another, the reaction of these components being a homogeneous catalyzed reaction of the solid borohydride. Alternatively, the acidic reagent may be stored in solid form to promote the reaction between sodium borohydride and water, the reaction of these components being a heterogeneous catalyzed reaction. In certain applications, the homogeneous reaction may be preferable over the heterogeneous reaction to provide some or all of the following advantages:
increased effective fuel energy as a result of removing the concentration limits imposed by heterogeneous catalyst operation;
improved stability of solid borohydride salts relative to solutions of borohydride salt; and
the system complexity y and overall BOP are reduced without a discrete catalyst bed to prevent potential fouling issues.

Systems for on demand hydrogen generation preferably have fast start and stop dynamics (to provide on/off control for hydrogen generation) under a range of environmental conditions encompassing cold winters to hot summers and generate minimal heat to limit the need for heat transfer and management devices. Furthermore, the system should rely on a fuel with high energy storage density that is stable under a variety of storage conditions. Hydrogen generation by the acid catalyzed hydrolysis of borohydrides occurs as shown in the following equations for a metal borohydride compound and hydrochloric acid:
MBH₄+6H₂O→MBO₂.4H₂O+4H₂ (3)
4MBH₄+2HCl+17H₂O→M₂B₇O₄.10H₂O+16H₂+2MCl (4)
MBH₄+4H₂O→MBO₃.H₂O+3H₂ (5)

As shown in equations (3), (4) and (5), borate compounds with varying numbers of associated water molecules can be formed depending on conditions within the reaction chamber. To maximize the conversion of water to hydrogen, it is preferred that less hydrated borate by-products be produced to prevent sequestration of the water by the borate products and to ensure that the maximum amount of stored water is available for hydrogen generation.

In typical hydrogen generation systems based on aqueous borohydride solutions and solid catalysts, the hydrated borate products trap more than 4 water molecules per boron atom (for example, Na₂B₂O₄.8H₂O is produced from the catalyzed hydrolysis of sodium borohydride). For such solution based systems, additional water is needed for effective hydrogen generation and dilute fuel concentrations are preferred, typically with borohydride/water ratios greater than 1:10. In contrast, the acid catalyzed hydrolysis of solid sodium borohydride forms less hydrated borate compounds. For example, borates such as Na₂B₄O₇.10H₂O, Na₂ClBO₂.2H₂O, and NaBO₃.H₂O with B/H₂O ratios of 2:5, 1:2 and 1:1, respectively, are formed by the reaction of dilute hydrochloric acid with solid sodium borohydride. These compounds sequester less water than the borate compounds produced by metal catalysis of a fuel solution, and thus reduce the demand for additional water. Consequently, acid catalyzed hydrolysis of solid chemical hydride offers higher energy storage densities than the solution based systems.

Storing borohydride in a dry form significantly increases fuel stability. In addition, the specific choice of fuel and acid may be varied to optimize the energy density of the hydrogen generation system. For example, the packing density of the stored NaBH₄ can be varied so that higher density packing will increase the system energy density. Various acids such as sulfuric, hydrochloric and phosphoric, for example, have the ability to vary the solution density and viscosity or diffusivity through the solid fuel and therefore may be chosen for a specific application.

Hydrogen generation by the acid catalyzed hydrolysis of borohydrides such as NaBH₄ occurs, initially, when water molecules contact a particle of NaBH₄ and the reaction takes place on the surface. As the reaction proceeds, a layer of borate can build up on the NaBH₄ core. The reaction of subsequent amounts of water depends on effectively penetrating the borate shell to reach the borohydride core. The observed reaction rate will therefore be a multi-dimensional function of a number of variables including, but not limited to, the intrinsic reaction rate, diffusion rate, boundary conditions, reactant concentrations, localized heating effects.

In preferred systems according to embodiments of the present invention, the rate of hydrogen generation and/or temperature of the system is regulated by varying the rate of acid addition to the solid borohydride, the concentration of the acid, or a combination of both. According to one embodiment of the present invention, the concentration of the acid may be varied by adding water directly to the reaction chamber or to the acid reagent solution feed. To maintain the reaction chamber at temperatures below about 100° C., which allows construction of hydrogen fuel systems that do not require extensive heat management elements, the concentration of the acid is typically between about 0.1 to about 17 M, preferably in the range of about 1 to about 10.5 M. The rate of acid addition determines the rate of hydrogen generation from the reaction of the acidic reagent with solid borohydride fuel. In turn, the rate of hydrogen production is defined by the demands of the fuel cell and the desired operating power. For example, a 15 W fuel cell operating at about 50% efficiency typically requires about 190 mL of hydrogen per minute (NTP). This can be obtained by delivering the acidic reagent at flow rates up to about 50 mL/h. Appropriate flow rates and hydrogen production rates for other power ranges can be readily determined by one skilled in the art given the teachings herein.

Systems for hydrogen generation based on the acid catalyzed hydrolysis of sodium borohydride can incorporate a liquid distributor to disperse the acid solution so that the diffusion path for the solution to reach unreacted chemical hydride is minimized. Elements which distribute liquids by capillary or wicking action through small pores or spaces can be used to enhance delivery of the acidic solution to the chemical hydride fuel. Reduction in the size of acid droplets also is beneficial to maintain a stable and steady flow of hydrogen in response to hydrogen demand. Examples of some suitable liquid distributors include spray nozzles, atomizers, and sparger tubes.

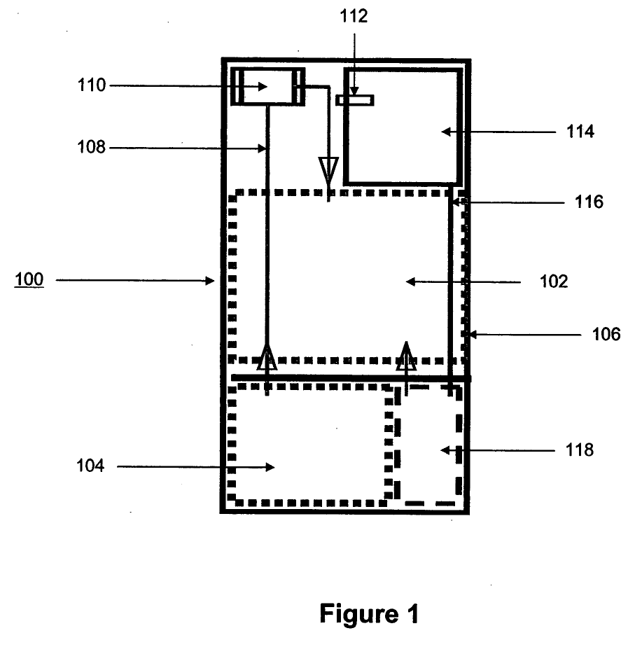

Referring to FIG. 1, a fuel cartridge 100 for a system for hydrogen generation from acid catalyzed hydrolysis of solid borohydride comprises a solid fuel storage region 102 and a liquid reagent storage region 104. The solid fuel, preferably a metal borohydride compound in a powder, granular, or pelletized form, is supplied to region 102 such that channels or paths are present within the bulk mass to allow liquid transport, preferably between about 0.1 and 2.5 g/cc, most preferably between about 0.5 and 1.5 g/cc. The solid fuel is preferably in a region bounded by an enclosure of which at least a portion thereof is a hydrogen permeable membrane 106. Suitable gas permeable membranes include those materials known to be more permeable to hydrogen than water such as silicon rubber, fluoropolymers or any hydrogen-permeable metal membrane such as palladium-gold alloy. Preferably, the hydrogen separation membrane is hydrophobic. This membrane will allow hydrogen gas to pass through, while substantially maintaining solids and liquids within region 102. The hydrogen gas can then accumulate, for example, in the voids of the fuel cartridge until required.

A control element 110 such as a pressure control valve or a pump may be employed to regulate the flow of acid from storage region 104 via conduit 108 to the solid storage region 102. For pressure control valves or other passive power control elements, when the pressure of hydrogen gas in the cartridge is greater than the set point, the valve closes, preventing contact of the acid catalyst and solid fuel. As hydrogen is consumed or removed from the cartridge, causing a pressure drop, the valve opens and allows contact of the acid catalyst with solid fuel to produce additional hydrogen gas. For active powered control elements such as a pump, a power source is necessary. The pump can be initially powered by a power source such as a battery (not illustrated) during fuel cell startup period, and then powered by the fuel cell. The pump rate can be controlled by either the hydrogen pressure in the fuel cartridge, power demand of the fuel cell, or a combination of these factors.

To maximize energy density, it is preferred that at least a portion of the solid fuel storage region 102 and the acid storage region 104 be flexible to allow a volume exchanging configuration such that when acid solution is consumed, region 104 shrinks while region 102 expands.

Cartridge 100 is illustratively shown with a PEM fuel cell 114 contained with the cartridge. Alternatively, the fuel cell could be external to the cartridge, and the cartridge used solely for storage of fuel components. The fuel cell may be any type of fuel cell that consumes hydrogen gas such as a PEM fuel cell, a solid oxide fuel cell (SOFC), or an alkaline fuel cell. The fuel cell is equipped with a hydrogen inlet 112 and an oxygen inlet (not shown) to intake the gaseous components necessary for electricity generation per equation (6) below as is typical for PEM fuel cells:
2H₂+O₂→2H₂O+e⁻ (6)

A byproduct of electricity generation is water. In a closed cartridge system, the water can be recovered from the fuel cell and transported via conduit 116 to water storage region 118. In such a configuration, it is preferable that acid region 104 and water region 118 are separated by a flexible or movable partition in a volume exchanging configuration. As acid is consumed to produce hydrogen, region 104 shrinks and, as water is produced by the fuel cell, region 118 expands. The water recovered from the fuel cell can be used to dilute the acid flow if desired.

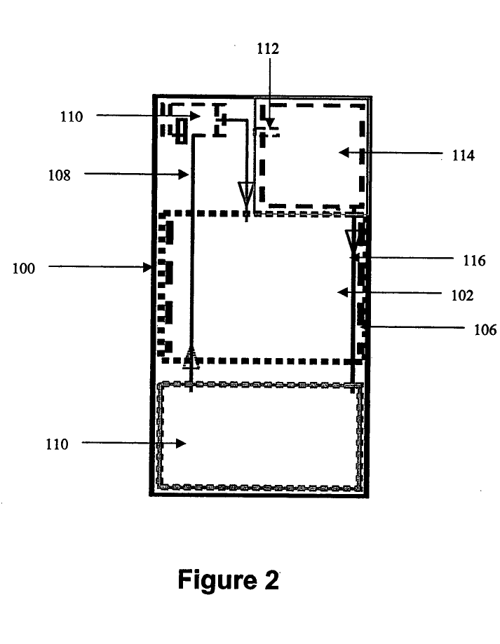

Referring to FIG. 2, wherein features that are similar to those shown in FIG. 1 have like numbering, an actively pumped system for hydrogen generation from acid catalyzed hydrolysis from sodium borohydride uses a pump 110. In this embodiment, the water from the fuel cell is delivered to the acid storage region 104 and a separate water storage region is eliminated.

In operation, a solution of acid is fed from storage region 104 to the fuel storage region 102. The reaction of acid and borohydride fuel generates hydrogen within region 102. The produced hydrogen can pass through the hydrogen separation membrane that bounds at least a portion of the fuel region 102 and accumulate within the cartridge body. The hydrogen passes through inlet 112 to the fuel cell for conversion to electricity.

The following examples further describe and demonstrate features of methods and systems for hydrogen generation and control according to the present invention. The examples are given solely for illustration purposes and are not to be construed as a limitation of the present invention. Various other approaches will be readily ascertainable to one skilled in the art given the teachings herein.

### EXAMPLE 1

System dynamics and H₂ flowrates were measured in a semi-batch reactor system with solid granular sodium borohydride loaded in a 250 mL Pyrex reactor. Hydrochloric acid (HCl) was fed by a syringe pump at the specified flow rates and duration (Table 1). Reaction temperature was monitored with an internal thermal couple. Hydrogen was cooled to room temperature through a water/ice bath and passed through a bed of silica gel to remove any moisture in the gas stream. The dried H₂ flow rate was measured with an on-line mass flow meter. Sodium borohydride conversion was analyzed using NMR of the post-reaction mixture after each run was completed.

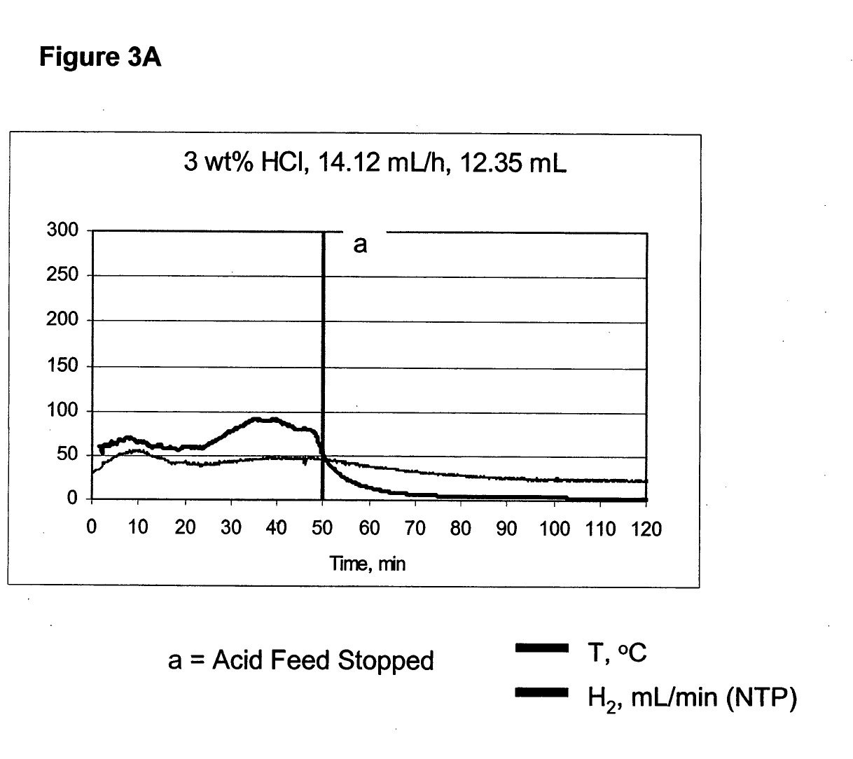

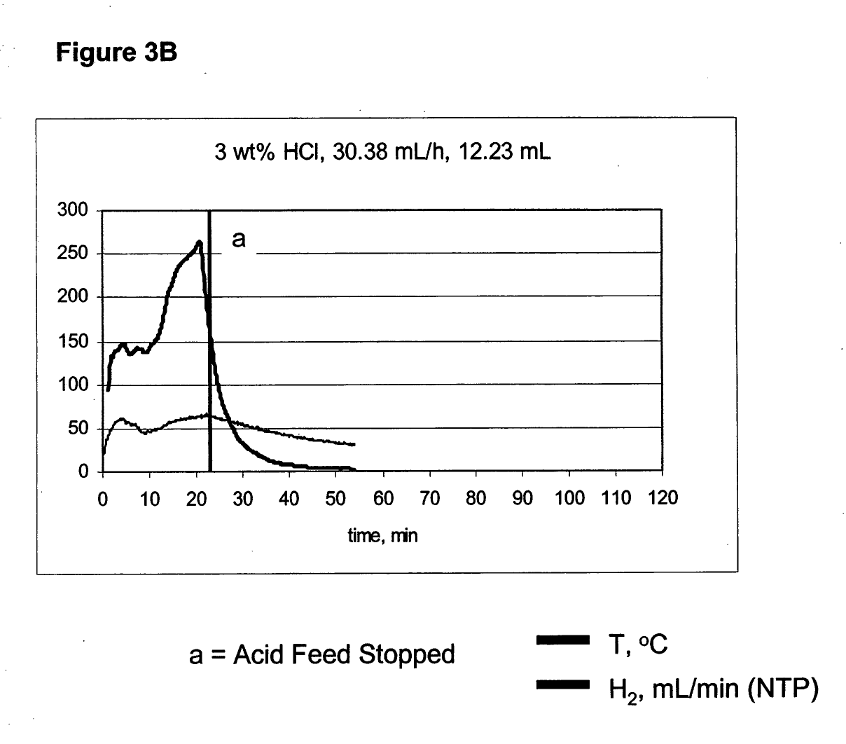

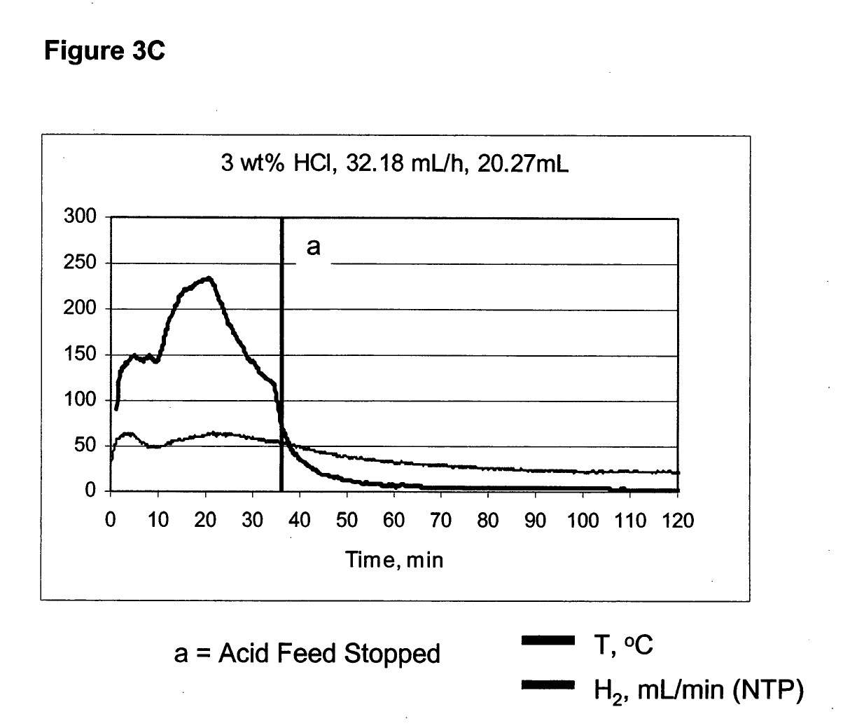

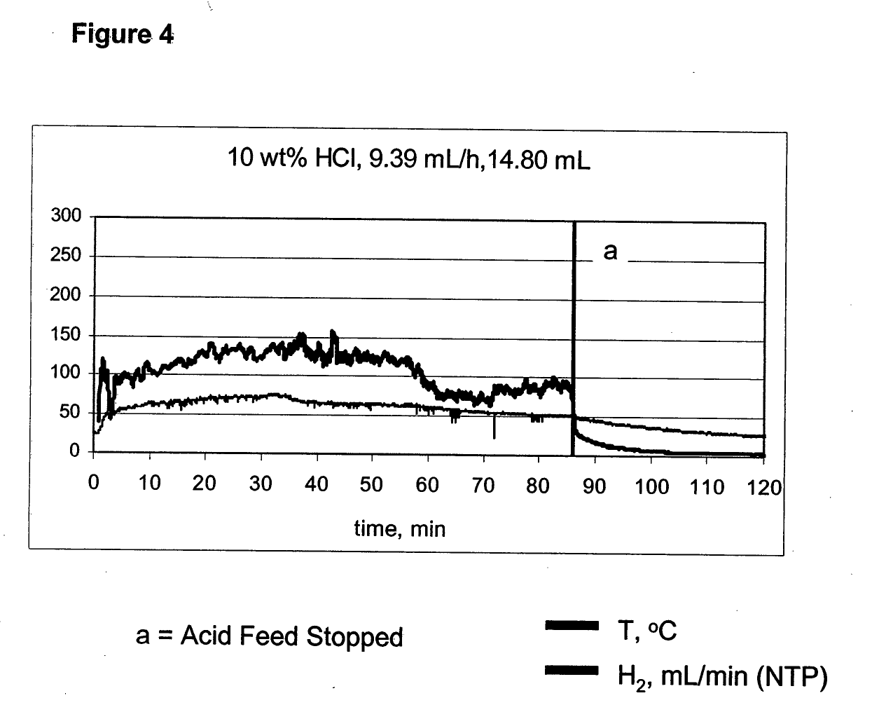

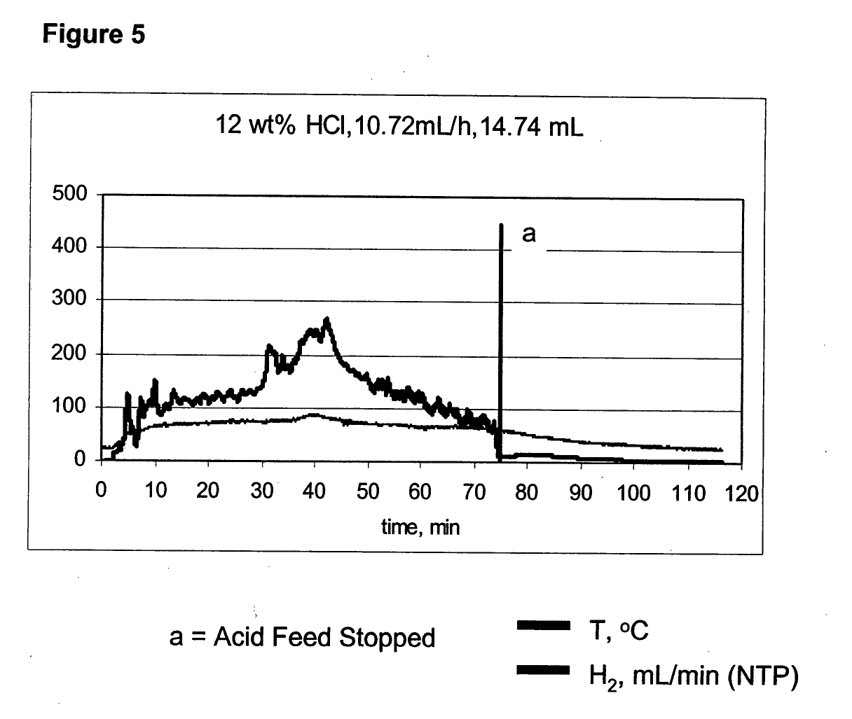

Reaction for hydrogen generation can be stopped at various conversion levels by stopping the acid solution feed. This provides an effective mechanism for controlling hydrogen generation. The flow rate of the acid can be used to regulate the maximum temperature of the system and the maximum hydrogen flow rate, as shown in FIGS. 3A, 3B and 3C (which illustrate a comparison of hydrogen production at different flow rates of the acid). Similar profiles were observed for other concentrations of acid, as shown in FIGS. 4 and 5, for example. The amount of acid delivered controls the total conversion of sodium borohydride and, thus, the total amount of hydrogen produced as shown by comparison of FIGS. 3B and 3C, and FIGS. 3, 4, and 5. Hydrogen production can be stopped by stopping the acid feed, at which point a noted decrease in hydrogen flow was observed. This point is illustrated in the graphs shown in FIGS. 3, 4 and 5. The representative runs are summarized in Table 1 below.

These runs demonstrate that desired dynamic characteristics for hydrogen generation based on acid catalyzed hydrolysis of solid sodium borohydride can be achieved by selecting the concentrations and feed rates of the acid solutions. Complete (e.g., greater than about 98%) sodium borohydride conversion was obtained with a reaction stoichiometry of H₂O:NaBH₄ of between 4:1 and 5.3:1.

TABLE 1
Acid catalyzed hydrogen generation

| HCl | | | % NaBH₄ | Total H₂ |
|---|---|---|---|---|
| Concentration, | Pump Rate, | Volume of | converted, by | Produced, |
| wt-% (M) | mL/h | acid, mL | NMR analysis | mL at NTP |
| 3 (0.8) | 14.12 | 12.35 | 35 | 4028 |
| 3 (0.8) | 32.18 | 20.27 | 57 | 6754 |
| 7 (1.92) | 9.27 | 9.77 | 43 | 5502 |
| 7 (1.92) | 9.39 | 14.7 | 61 | 7114 |
| 10 (2.7) | 9.39 | 12.86 | 98 | 9602 |
| 10 (2.7) | 8.76 | 9.80 | 63 | 6999 |
| 12 (3.3) | 9.05 | 12.27 | 80 | 9798 |
| 12 (3.3) | 9.24 | 17.14 | 99 | 11976 |
| 15 (4.1) | 9.07 | 9.65 | 76 | 9190 |
| 15 (4.1) | 9.42 | 17.44 | 100 | 12855 |
| 20 (5.5) | 9.23 | 9.98 | 85 | 10680 |
| 20 (5.5) | 10.31 | 17.35 | 100 | 12891 |
| 37 (10.1) | 10.04 | 12.74 | 98 | 11620 |
| 37 (10.1) | 10.79 | 15.49 | 100 | 12526 |

### EXAMPLE 2

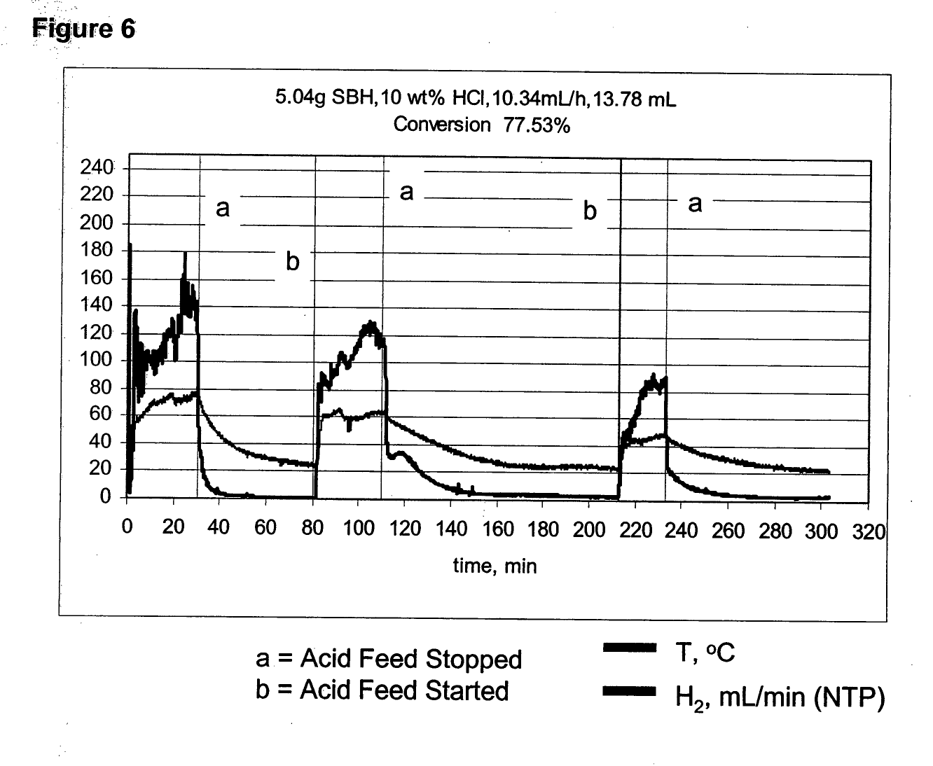

Using the procedures described in Example 1, dynamic hydrogen generation rates were measured after periodic start-stop cycles with an acid solution feeding rate of 10 mL/h of 10 wt-% HCl. The acid flow was started and stopped repeatedly, and the reactor cooled to ambient temperature between stop/start cycles, to measure hydrogen generation rate as shown in FIG. 6. As the reaction proceeds, the solid sodium borohydride is converted to a mixture of borate compounds. The droplet of acid solution diffuses through these products to reach unreacted sodium borohydride, resulting in somewhat decreased reaction rates for the 3^{rd} cycle, though startup and stop dynamics remained fast.

### EXAMPLE 3

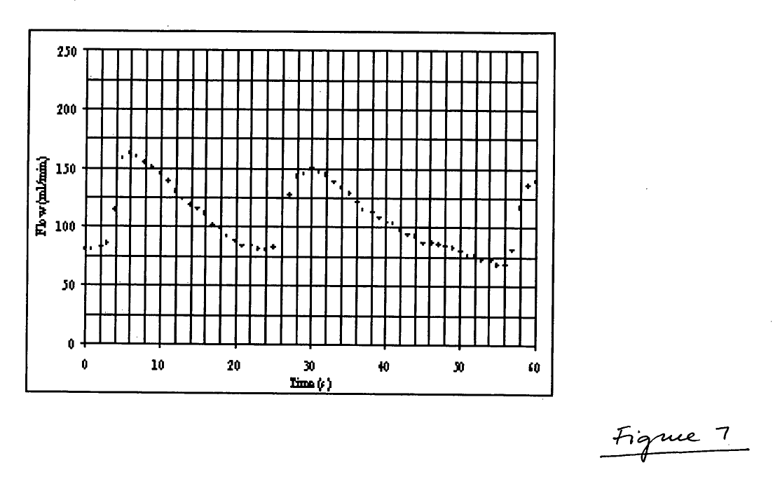

According to one experiment, a 1 wt % aqueous hydrochloric acid solution was added drop-wise to 5 g of solid NaBH₄ in a sealed container. The hydrogen evolved from this reaction was monitored with a mass flow meter. FIG. 7 depicts the hydrogen flow rate upon addition of acidified water. Under the conditions of the experiment, the amount of hydrogen evolved is directly proportional to the amount of acid added, and the integrated yield of hydrogen corresponds to about 100% conversion of borohydride to hydrogen. The system response after hydrogen addition was also rapid, of less than about 5 s. The amount of water added to NaBH₄ was about 5 times the molar amount of NaBH₄.

### EXAMPLE 4

A Pyrex reactor (250 mL) was charged with a 5.75 g of solid fuel formulation that contains 87-wt % sodium borohydride and 13-wt % NaOH. Prior to startup of hydrogen generation reactions, the reaction system was leak-checked with N₂ then purged thoroughly with H₂. The reaction temperature was monitored with an embedded thermal couple. After the reactor was sealed and purged with pure hydrogen, 20 wt % HCl was introduced to the reaction chamber through a syringe pump at a constant pump rate of about 10 mL/h.

Hydrogen generated was cooled down to room temperature through a water/ice bath, then passed through a silica gel drier to remove any moisture in the gas stream. Dry H₂ flow rate was then measured using an on-line mass flow meter and computer data acquisition system. Rate of H₂ generation, reaction temperature, reactor wall and H₂ temperatures, and system pressure were all recorded using an on-line computer. To measure the stop characteristics of the hydrogen generation reaction, the acid-feeding pump was stopped at various chemical hydride conversion levels and the hydrogen flow rates after stopping acid feeding were recorded. Total amount of hydrogen generated in each run was established by numerical integration of dynamic hydrogen flow profile.

Hydrogen generated was passed through a heat exchanger to cool down to about 21° C. The cooled hydrogen gas was subsequently passed through a silica gel trap for moisture removal. Flow rate of dry hydrogen was then measured using a mass flow meter. To measure the stop characteristics of the hydrogen generation reaction, the acid-feeding pump was stopped at various chemical hydride conversion levels and the hydrogen flow rates after stopping acid feeding were recorded. Total amount of hydrogen generated in each run was established by numerical integration of dynamic hydrogen flow profile. After each run, reaction products in the reaction chamber were collected for NMR analysis and NMR results were used to establish sodium borohydride conversion.

Controlled hydrogen generation was achieved with delivery of 13.9 mL of HCl for greater than 94% sodium borohydride conversion.

The above description and drawings are only to be considered illustrative of exemplary embodiments, which achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

1. A method of generating hydrogen gas, comprising:
providing a fuel in solid form, the fuel being capable of generating hydrogen when brought into contact with a reagent and water;
providing an acidic reagent; and
contacting the acidic reagent with the solid fuel in the presence of water to generate hydrogen gas and a borate by-product.

2. The method of claim 1, wherein the fuel comprises at least one borohydride salt of formula M(BH₄)ₙ, wherein M is selected from the group consisting of alkali metal cations, alkaline earth metal cations, aluminum cation, zinc cation, and ammonium cation, and n corresponds to the charge of the selected M cation.

3. The method of claim 2, wherein the fuel is combined with a solid stabilizer agent selected from the group consisting of metal hydroxides, anhydrous metal metaborates, and hydrated metal metaborates, and mixtures thereof.

4. The method of claim 2, wherein the molar ratio of water to borohydride is between about 4:1 to about 5.3:1.

5. The method of claim 4, wherein the molar ratio of water to borohydride is about 4:1.

6. The method of claim 1, wherein the fuel comprises a material selected from the group consisting of sodium borohydride, lithium borohydride, potassium borohydride, and calcium borohydride, and mixtures thereof.

7. The method of claim 1, wherein the fuel comprises a material selected from the group consisting of sodium borohydride dihydrate, potassium borohydride trihydrate, and potassium borohydride monohydrate, and mixtures thereof.

8. The method of claim 1, wherein the reagent is in the form of a solid.

9. The method of claim 1, wherein the reagent is in the form of a liquid solution.

10. The method of claim 1, further comprising contacting the fuel with a co-catalyst.

11. The method of claim 10, wherein the co-catalyst comprises a transition metal salt.

12. The method of claim 11, wherein the transition metal salt is a cobalt salt, nickel salt or copper salt.

13. The method of claim 1, wherein the reagent comprises a material selected from the group consisting of hydrochloric acid, sulfuric acid, phosphoric acid, acetic acid, formic acid, maleic acid, citric acid, and tartaric acid.

14. The method of claim 1, wherein the concentration of the acidic reagent is between 0.1 and 17 M.

15. The method of claim 14, wherein the concentration of the acidic reagent is between 1 and 10 M.

16. A method of generating hydrogen, comprising:
providing at least one solid borohydride of formula M(BH₄)ₙ, wherein M is selected from the group consisting of alkali metal cations, alkaline earth metal cations, aluminum cation, zinc cation, and ammonium cation, and n corresponds to the charge of the selected M cation; and
contacting the solid borohydride with a liquid reagent having a pH lower than about 7 to generate hydrogen.

17. The method of claim 16, wherein the solid borohydride is selected from the group consisting of sodium borohydride, lithium borohydride, potassium borohydride, and calcium borohydride, and mixtures thereof.

18. The method of claim 16, wherein the solid borohydride is selected from the group consisting of sodium borohydride dihydrate, potassium borohydride trihydrate, and potassium borohydride monohydrate, and mixtures thereof.

19. The method of claim 16, wherein the reagent is selected from the group consisting of hydrochloric acid, sulfuric acid, phosphoric acid, acetic acid, formic acid, maleic acid, citric acid, and tartaric acid.

20. The method of claim 16, wherein contacting the solid borohydride further comprises contacting with a transition metal salt catalyst.

21. The method of claim 20, wherein the transition metal salt catalyst is a cobalt salt, nickel salt or copper salt.

22. The method of claim 16, wherein the solid borohydride is provided in the form of granules, pellets or powder, or a combination thereof.

23. The method of claim 16, further comprising dispersing the acidic reagent solution prior to contacting the solid borohydride.

24. The method of claim 23, wherein dispersing reduces the size of the droplets of the acidic reagent solution using a mechanism selected from the group consisting of atomizers, spray nozzles, and sparge tubes.

25. The method of claim 16, wherein the molar ratio of H₂O to borohydride is between about 4:1 to about 5.3:1.

26. The method of claim 25, further comprising generating a hydrated borate having a molar ratio of H₂O to boron of about 1:1.

27. A method of producing and controlling the production of hydrogen, comprising:
providing a solid borohydride of formula M(BH₄)ₙ, wherein M is selected from the group consisting of alkali metal cations, alkaline earth metal cations, aluminum cation, zinc cation, and ammonium cation, and n corresponds to the charge of the selected M cation;
contacting the solid borohydride with an aqueous acidic reagent solution in a reaction chamber to generate hydrogen; and
regulating the rate or concentration of the acidic reagent solution contacting the solid borohydride, to control the rate of hydrogen generation.

28. The method of claim 27, comprising regulating the rate of the acidic reagent solution.

29. The method of claim 27, wherein the reactor temperature is maintained at below about 100° C.

30. The method of claim 27, further comprising converting the solid borohydride to hydrogen and a borate compound by hydrolyzing the borohydride in the presence of the acidic solution.

31. The method of claim 30, wherein the solid borohydride comprises sodium borohydride.

32. The method of claim 30, wherein the acidic solution comprises hydrochloric acid.

33. The method of claim 30, further comprising cooling the hydrogen.

34. The method of claim 30, wherein the ratio of B/H₂OOin the borate compound is about 1:2.

35. The method of claim 30, wherein the ratio of B/H₂O in the borate compound is about 2:5.

36. The method of claim 30, wherein the ratio of B/H₂O in the borate compound is about 1:1.

37. The method of claim 30, wherein the acidic solution comprises a co-catalyst.

38. The method of claim 37, wherein the co-catalyst is a transition metal salt.

39. A hydrogen gas generation system, comprising:
a first region for containing a solid borohydride;
a second region for containing a reagent solution having a pH of less than about 7; and
at least one gas permeable membrane in contact with the first region, wherein the membrane is capable of allowing hydrogen to pass through the membrane while preventing solid and liquid materials from passing through the membrane.

40. The hydrogen gas generation system of claim 39, further comprising:
a conduit for conveying the reagent solution from the second region to the first region; and
a hydrogen gas outlet in communication with the first region.

41. The hydrogen gas generation system of claim 40, further comprising a control mechanism for regulating the flow of reagent solution from the second region to the first region.

42. The hydrogen gas generation system of claim 41, wherein the control mechanism comprises a pressure control valve.

43. The hydrogen gas generation system of claim 41, wherein the control mechanism comprises a pump.

44. The hydrogen gas generation system of claim 39, wherein at least one of the first and second regions is bounded by a movable material to provide a volume exchanging configuration.

45. The hydrogen gas generation system of claim 39, wherein at least one of the first and second regions is bounded by a flexible material to provide a volume exchanging configuration.

46. The hydrogen gas generation system of claim 39, wherein the solid borohydride has formula M(BH₄)ₙ, wherein M is selected from the group consisting of alkali metal cations, alkaline earth metal cations, aluminum cation, zinc cation, and ammonium cation, and n corresponds to the charge of the selected M cation.

47. The hydrogen gas generation system of claim 39, wherein the solid borohydride is selected from the group consisting of sodium borohydride, lithium borohydride, potassium borohydride, and calcium borohydride, and mixtures thereof.

48. The hydrogen gas generation system of claim 39, wherein the solid borohydride is selected from the group consisting of sodium borohydride dihydrate, potassium borohydride trihydrate, and potassium borohydride monohydrate, and mixtures thereof.

49. The hydrogen gas generation system of claim 39, wherein the reagent solution comprises an acid selected from the group consisting of hydrochloric acid, sulfuric acid, phosphoric acid, acetic acid, formic acid, maleic acid, citric acid, and tartaric acid.

50. A hydrogen gas generation system comprising:
a fuel chamber for storing a solid borohydride having formula M(BH₄)ₙ, wherein M is selected from the group consisting of alkali metal cations, alkaline earth metal cations, aluminum cation, zinc cation, and ammonium cation, and n corresponds to the charge of the selected M cation;
a reagent chamber for storing an acidic reagent solution;
at least one gas permeable membrane provided in contact with the fuel chamber to allow hydrogen to pass through the gas permeable membrane while preventing solid and liquid materials from passing through the gas permeable membrane;
a fuel conduit for conveying the acidic reagent solution from the reagent chamber to the fuel chamber; and
a control mechanism for regulating the flow of acidic reagent solution from the reagent chamber to the fuel chamber.

51. The hydrogen gas generation system of claim 50, wherein at least one of the fuel chamber and the reagent chamber comprises a flexible material.

52. The hydrogen gas generation system of claim 50, wherein the acidic reagent solution comprises an acid selected from the group consisting of hydrochloric acid, sulfuric acid, phosphoric acid, acetic acid, formic acid, maleic acid, citric acid, and tartaric acid.

53. The hydrogen gas generation system of claim 50, wherein the control mechanism is a pressure control valve or a pump.

54. The hydrogen gas generation system of claim 50, wherein the solid borohydride is provided in a form selected from the group consisting of pellets, granules and powder.

55. The hydrogen gas generation system of claim 50, wherein the solid borohydride contains less than about 50% by weight water.

56. The hydrogen gas generation system of claim 50, wherein the solid borohydride is sodium borohydride dihydrate and the acidic reagent solution comprises hydrochloric acid.

57. The hydrogen gas generation system of claim 50, wherein the system is connected to a fuel cell.

58. A hydrogen gas generation system, comprising:
a first chamber for storing solid sodium borohydride;
a second chamber for storing a hydrochloric acid solution; and
a control means for regulating the rate of contact between the solid sodium borohydride and the hydrochloric acid solution to allow conversion of the sodium borohydride to generate hydrogen gas.

59. The hydrogen gas generation system of claim 58, further comprising at least one gas permeable membrane provided in contact with the first chamber, to allow hydrogen to pass through the gas permeable membrane.

60. The hydrogen gas generation system of claim 58, wherein the second chamber further comprises a transition metal salt catalyst.

61. The hydrogen gas generation system of claim 60, wherein the transition metal salt catalyst is a cobalt salt, nickel salt or copper salt.
